(19) United States
(12) Patent Application Publication
(10) Pub. No.: US 2003/0132417 A1
(43) Pub. Date: Jul. 17, 2003

(54) Method and apparatus for preparing slurry for CMP apparatus

(75) Inventor: Shigeki Kobayashi, Mitaka-shi (JP)

Correspondence Address: NIXON PEABODY, LLP, 8180 GREENSBORO DRIVE, SUITE 800, MCLEAN, VA, 22102, US

(73) Assignee: TOKYO SEIMITSU CO., LTD.

(21) Appl. No.: 10/339,593

(22) Filed: Jan. 10, 2003

(30) Foreign Application Priority Data
Jan. 11, 2002 (JP) 2002-4416

(51) Int. Cl. A62D 1/00; A62C 2/00

(52) U.S. Cl. 252/2

(57) ABSTRACT

The method and apparatus are provided for preparing a slurry for a CMP apparatus with simple configuration with which mixing accuracy for the slurry is improved and measurement is automatically accomplished for as a small amount of additive. A slurry preparation apparatus for a CMP apparatus comprises a tank for preparing the slurry, a weight sensor provided to the tank, and a stock solution feeder for the slurry which feeds a stock solution for the slurry into the tank. The weight sensor measures the weight of the tank, and the amount of the slurry to be supplied is controlled according to the measurements.

### BACKGROUND OF THE INVENTION

1. Field of the Invention

The present invention relates to a method and apparatus for preparing a slurry for a Chemical Mechanical Polishing (CMP) apparatus.

2. Description of the Related Art

As semiconductor integrated circuit design rules shrink, CMP has gained popularity in processes for planarizing layers such as interlayer films. Most of slurries used for CMP comprise a solid-liquid dispersion system in which fine particles are dispersed in an aqueous solution with reagents such as a pH adjuster. The slurries are available from a variety of slurry manufactures as a stock slurry solution in the form of liquid. A small amount (e.g., on the order of 2% by weight in the resultant solution) of hydrogen peroxide (H₂O₂) is a common additive for the stock slurry solution. Thus, the stock slurry solution and the additive and the like are materials for the slurry.

A common apparatus for preparing a slurry for a polishing apparatus is of a type shown in a cross-section in FIG. 3. The slurry preparation apparatus can also function as a slurry tank (slurry feeder) for supplying the slurry.

In FIG. 3, the slurry preparation apparatus 1 has pipes 2, 3 and 4 inserted into a bath through an upper lid. A pipe 5 is connected to the bottom of the bath. The pipe 2 is for supplying the stock slurry solution (as it is purchased from a manufacturer) and the pipe 3 for supplying an additive. The pipe 5 is for drawing and supplying the slurry to a slurry feeder, and the pipe 4 for returning the slurry back into the bath.

The pipes 4 and 5 are connected to a CMP apparatus, and used for supplying the slurry from the slurry feeder 1 to the CMP apparatus while circulating the slurry. A pipe 6 is connected between the pipes 4 and 5, and serves as a bypass between the pipes 4 and 5 that circulate the slurry between the slurry feeder 1 and the CMP apparatus. Additionally, a pump 7 and valves 8 and 9 are provided as auxiliary equipment.

The preparation of the slurry is accomplished by supplying the stock slurry solution and the additive through the pipes 2 and 3, respectively, and stirring them with a stirrer, not shown. Similarly, the stock slurry solution and the additive are supplied and stirred to prepare the slurry as it is lessened in the slurry feeder 1.

In the operation, the amount of the stock slurry solution and the additive supplied are managed using level gauges (not shown) disposed within the slurry feeder 1.

In preparing the slurry in the above-described conventional slurry feeder 1, however, there arises a problem that the amount of the stock slurry solution and the additive supplied can not accurately be managed: the surface of the slurry is constantly fluctuating in the slurry feeder 1, and does not exhibit a mirror surface of liquid. A measurement error in a level gauge, therefore, is unavoidable. Additionally, it is often difficult to provide mounting accuracy for the level gauge.

In this case, a measurement error may not have a significant impact when introducing the stock slurry solution, which occupies as much as 98% in the resultant slurry. It may represent a large difference in the consequence when introducing a small amount (e.g., on the order of 2% by weight in the resultant slurry) of the additive (e.g., hydrogen peroxide), significantly affecting a resultant quality of polishing.

Other measurement devices include a pipette, microsyringe, and the like as used for improving measurement accuracy for a small amount of additive. These, however, require manual operation that is not suitable to a process control. There are other complex devices for automatically, accurately measuring a small amount of additive. These complex devices are not preferable in terms of contamination, corrosion and the like of the measurement devices in the slurry feeder 1 and an environment surrounding the slurry feeder 1.

### SUMMARY OF THE INVENTION

The present invention has been made in view of these circumstances, and it is an object of the present invention to provide a method and apparatus for preparing a slurry for a CMP apparatus with simple configuration with which mixing accuracy for a slurry is improved and measurement is automatically accomplished for a small amount of additive.

To attain the above-described object, the present invention is directed to an apparatus for preparing a slurry for a CMP apparatus, comprising: a tank for preparing the slurry; a weight sensor provided to the tank; and a stock solution feeder which feeds a stock solution for the slurry into the tank, wherein a weight of the tank is measured by the weight sensor, and an amount of the stock solution for the slurry to be supplied is controlled according to the measured weight of the tank.

The present invention is also directed to a method for preparing a slurry for a CMP apparatus, comprising the steps of: measuring a weight of a tank for preparing the slurry with a weight sensor; and controlling an amount of a stock solution for the slurry to be supplied according to the measured weight of the tank.

According to the present invention, a weight of a tank is measured by a weight sensor provided to the tank for preparing the slurry, and the amount of stock slurry solution to be supplied is controlled according to the measurements. The present invention, therefore, provides for high mixing accuracy for a slurry, automatic measurement for a small amount of additive, simple configuration, and compatibility with an environment surrounding a slurry feeder. Similarly, the weight sensor does not need to take contamination, corrosion and the like of the detection devices into account in the slurry feeder because it is provided outside a tank for preparing the slurry.

### BRIEF DESCRIPTION OF THE DRAWINGS

The nature of this invention, as well as other objects and advantages thereof, will be explained in the following with reference to the accompanying drawings, in which like reference characters designate the same or similar parts throughout the figures and wherein:

FIG. 1 shows a schematic view of the entire configuration of an apparatus for preparing a slurry according to the present invention;

FIG. 2 shows an exemplary screen of a computer for an apparatus for preparing a slurry; and

FIG. 3 shows a schematic sectional view of an example of a conventional apparatus for preparing a slurry.

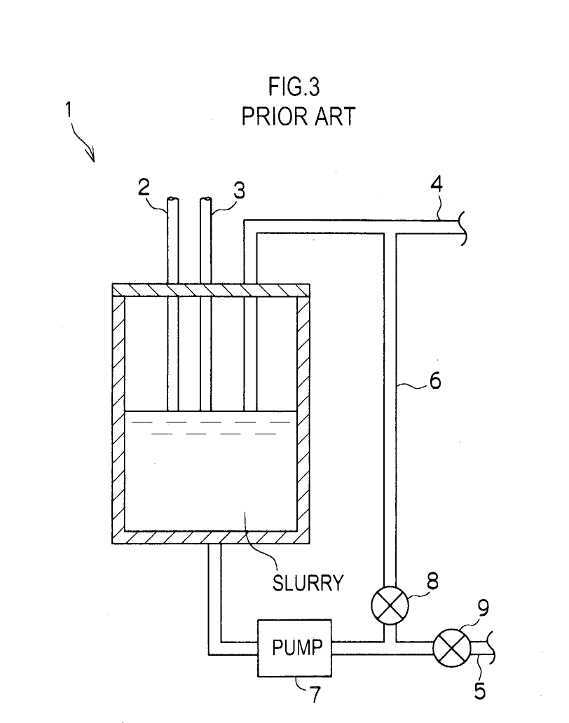

### DETAILED DESCRIPTION OF THE PREFERRED EMBODIMENTS

A preferred embodiment of a method and apparatus for preparing a slurry for a CMP apparatus according to the present invention will now be described with reference to the drawings.

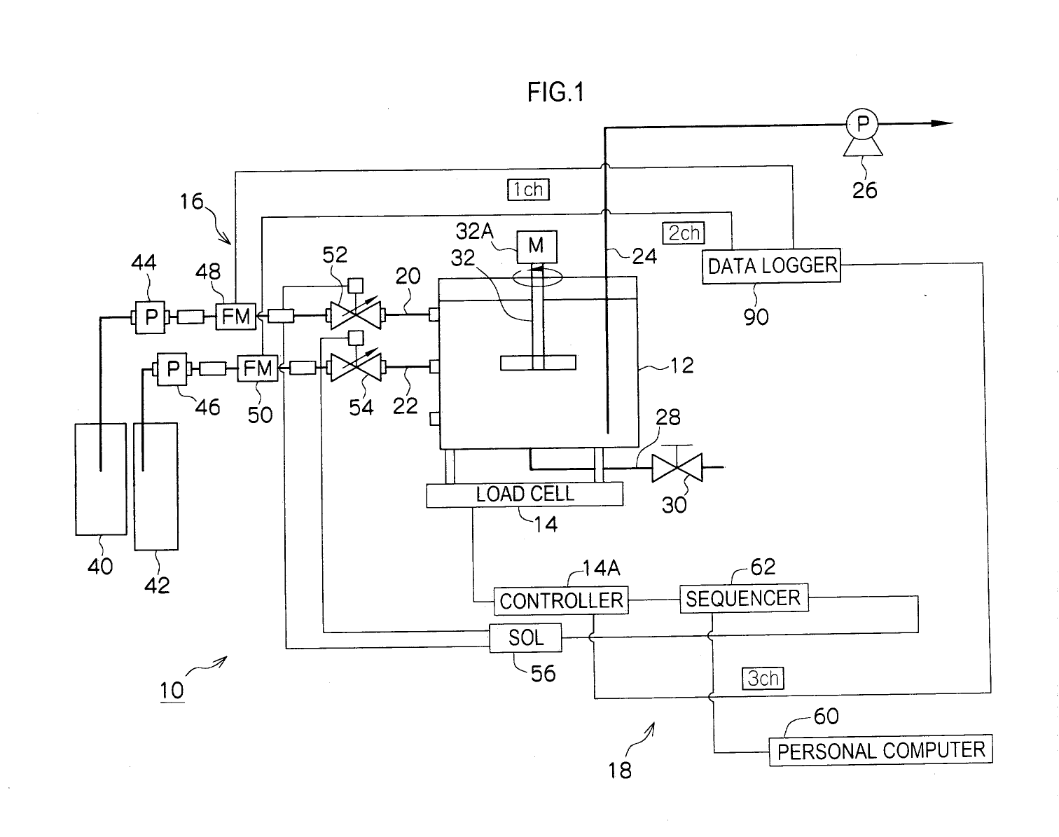

FIG. 1 shows a schematic view of the entire configuration of a slurry preparation apparatus 10 according to the present invention. The slurry preparation apparatus 10 comprises a tank 12 for preparing a slurry, a weight sensor 14, a stock solution feeder 16 for a slurry, and a control device 18 for controlling the system.

The tank 12 for preparing the slurry is a cylindrical tank made of plastic and fixed on a load cell that is the weight sensor 14, so that the weight sensor 14 bears the entire weight of the tank 12.

Pipes 20 and 22 are in communication with inside of the tank 12 through a side thereof. A pipe 24 is also provided through the upper lid. The pipe 24 is connected to a pump 26 and routed to a polishing apparatus for drawing and supplying the slurry to the polishing apparatus. A pipe 28 is connected to the bottom of the tank 12, and a valve 30 located on the end of the pipe 28 can be operated to drain the content of the tank 12.

The tank 12 is provided with a stirrer 32 for stirring the content. Stirring with the stirrer 32 is accomplished by rotating blades located on the end of a shaft that is driven by a motor 32A.

These pipes 20, 22, 24 and 28, as well as the stirrer 32 that are connected to the tank 12 are loosely connected thereto such that an error can not be introduced into a weight measurement by the weight sensor 14. Such a configuration may be obtained by using, for example, flexible tubes and the like.

Typically, the weight sensor 14 may preferably be a load cell, although it may be anything that can sense and extract as an electrical signal the weight of the tank 12 fixed thereon. Such a load cell that may be used includes, for example, the model TTS-100-1300-SW205 load cell (the model MX-8800 may be used as a controller 14A) from Technical & Try Inc. The indication of the load cell ranges from 0 to 15 kg, and 0 to 5000 mV can be obtained as an analog output.

The analog output from the controller 14A is sent to a computer (e.g., a personal computer) 60 through a sequencer 62 described below. Alternatively, a configuration may be adopted for directly routing the analog or digital output from the controller 14A to the computer 60.

The stock solution feeder 16 comprises stock solution tanks 40 and 42 for storing a stock slurry solution and an additive solution, etc. supplied to the tank 12, liquid pumps 44 and 46 for supplying the stock slurry solution and the additive solution from these tanks, flow meters 48 and 50, valves 52 and 54 that turn on/off the supply, and the above-mentioned pipes 20 and 22 that are provided to connect the liquid pumps 44 and 46, the flow meters 48 and 50, the valves 52 and 54 in line from the stock solution tanks 40 and 42 through the tank 12.

In this configuration, diaphragm pumps are used as the liquid pumps 44 and 46, although any other types of pumps that reliably transport the stock slurry solution and the additive solution, etc. may be used.

The flow meters 48 and 50 may be of a type that can visually be read such as a tapered tube flow meter, and preferably of a type that can extract measured values as an electrical signal, such as an electromagnetic flow meter. These outputs are sent through signal lines (Channel 1 and Channel 2) to the data logger 90 for storage, as described below.

The valves 52 and 54 are of a type that can turn on/off the supply as the control device 18 drives a solenoid 56, as described below.

The control device 18 comprises the computer (personal computer) 60 that controls the entire slurry preparation apparatus, the sequencer 62 that receives a command from the computer 60 and controls the solenoid 56 that turns on/off the valves 52 and 54.

Additionally, the data logger 90 is provided to receive signals sent from the flow meters 48, 50 and the controller 14A of the weight sensor 14, and record sequential measurements on the flow of the stock slurry solution and the additive solution, etc. as well as the weight of the tank 12 (via Channel 3).

The valve 30 is provided to use in draining the content of the tank 12, etc. and the valve 30 can also be operated to draw a mixed slurry for such a task in which it may be monitored using a hydrometer of a float-type and the like.

The flow meters 48, 50 and the data logger 90 are not essential requirements for the present invention.

A method for preparing a slurry in the slurry preparation apparatus 10 configured as described above will now be described. A sequence in which a new slurry is prepared in an empty tank 12 is described here.

First, the weight sensor 14 measures the weight of the empty tank 12, and an output from the controller 14A of the weight sensor 14 is sent to the computer 60 via the sequencer 62 and stored thereon.

The liquid pump 44 is then driven, and the additive (hydrogen peroxide in this case) in the stock solution tank 40 is supplied into the tank 12. At this time, the valve 52 is in ON (opened) state. Upon the weight of the tank 12 reaches a predetermined weight value (the weight is determined by the computer 60), the computer 60 controls the solenoid 56 via the sequencer 62, bringing the valve 52 into OFF (closed) state. This causes the additive solution supply to stop.

The liquid pump 46 is then driven, and a stock slurry solution in the stock solution tank 42 is supplied into the tank 12. At this time, the valve 54 is brought into ON (opened) state. Upon the weight of the tank 12 reaches a predetermined weight value (the weight is determined by the computer 60), the computer 60 controls the solenoid 56 via the sequencer 62, bringing the valve 54 into OFF (closed) state. This causes the stock slurry solution supply to stop.

Simultaneously with the above operations, the supplied additive solution and the stock slurry solution are stirred in the tank 12 by the stirrer 32 and uniformly mixed.

The data logger 90 receives signals sent from the flow meters 48, 50 and the controller 14A of the weight sensor 14, and records sequential measurements on the flow of the stock slurry solution and the additive solution, etc., and the weight of the tank 12, etc.

The preferred embodiment of the method and apparatus for preparing a slurry for a CMP apparatus according to the present invention has been described. The present invention, however, is not limited to the illustrative embodiment described above, and various aspects may be implemented.

### EXAMPLES

Examples according to the present invention will now be described. Performance of the apparatus has been evaluated by using the slurry preparation apparatus 10 in the configuration as shown in FIG. 1 to mix two types of liquids having different specific gravities and comparing the measured specific gravity of the mixture with a predefined specific gravity (calculated value) of the mixture.

The following two types of liquids were used: a liquid having a specific gravity of 1.05 for liquid A, and a liquid having a specific gravity of 1.00 for liquid B. The specific gravity was measured by an hydrometer.

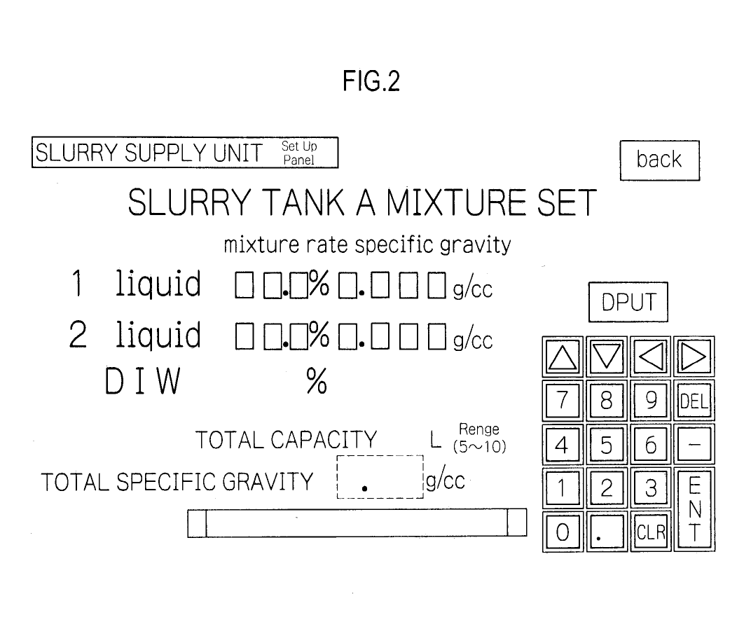

A pattern as shown in FIG. 2 is displayed on a screen of the computer (PC) 60 for the slurry preparation apparatus 10 such that a mixture rate and specific gravity for each type of liquid (and deionized water may be used if required) can be entered. A total capacity according to entered values and a calculated total specific gravity of the mixture is calculated and displayed.

Three conditions were used for the evaluation. In a first example, a mixture ratio (capacity ratio) of 1:1 for the liquid A to the liquid B is used. In a second example, a mixture ratio (capacity ratio) of 1:3 for the liquid A to the liquid B is used. In a third example, a mixture ratio (capacity ratio) of 1:19 for the liquid A to the liquid B is used. In each example, the evaluation was repeated three times and an average was determined.

In the first example, the calculated value was 1.025, and the measured value 1.025: both the calculated and measured values coincided.

In the second example, the calculated value was 1.0125, and the measured value 1.0123: the calculated and measured values did not coincide, but were close to each other.

In the third example, the calculated value was 1.0025, and the measured value 1.0019: the calculated and measured values did not coincide, but were close to each other.

According to the present invention, a weight sensor measures the weight of a tank, and the amounts of stock slurry solution and additive solution to be supplied are controlled according to the measurements, as described above. The present invention, therefore, provides for high mixing accuracy for a slurry, automatic measurement for a small amount of additive, simple configuration, and compatibility with an environment surrounding a slurry feeder. Similarly, the weight sensor does not need to take contamination, corrosion and the like of the measuring devices into account in the slurry feeder because it is provided outside a tank for preparing the slurry.

It should be understood, however, that there is no intention to limit the invention to the specific forms disclosed, but on the contrary, the invention is to cover all modifications, alternate constructions and equivalents falling within the spirit and scope of the invention as expressed in the appended claims.

What is claimed is:

1. An apparatus for preparing a slurry for a CMP apparatus, comprising:
a tank for preparing the slurry;
a weight sensor provided to the tank; and
a stock solution feeder which feeds a stock solution for the slurry into the tank, wherein a weight of the tank is measured by the weight sensor, and an amount of the stock solution for the slurry to be supplied is controlled according to the measured weight of the tank.

2. A method for preparing a slurry for a CMP apparatus, comprising the steps of:
measuring a weight of a tank for preparing the slurry with a weight sensor; and
controlling an amount of a stock solution for the slurry to be supplied according to the measured weight of the tank.
